(19) United States
(12) Patent Application Publication
(10) Pub. No.: US 2013/0135895 A1
(43) Pub. Date: May 30, 2013

(54) SURFACE LIGHT SOURCE DEVICE

(71) Applicant: Panasonic Liquid Crystal Display Co., Ltd., Himeji-shi (JP)

(72) Inventor: Yoshinori OHSHIMA, Osaka (JP)

(73) Assignee: PANASONIC LIQUID CRYSTAL DISPLAY CO., LTD., Himeji-shi (JP)

(21) Appl. No.: 13/689,256

(22) Filed: Nov. 29, 2012

(30) Foreign Application Priority Data
Nov. 30, 2011 (JP) 2011-261219

(51) Int. Cl. F21V 7/00; F21V 13/00

(52) U.S. Cl. CPC F21V 7/005; F21V 13/00
USPC 362/607; 362/609

(57) ABSTRACT

A surface light source device is provided. In a rear surface of a light guide plate (10), a groove (18) is formed crossing a center portion of the light guide plate (10). LEDs (12) are arranged linearly in the groove (18), and light enters the light guide plate (10) from side surfaces of the groove (18). Mirror-finished reflective sheets (14) are bonded at edge faces of the light guide plate (10) so that light is mirror-reflected to return toward the light guide plate (10), to thereby improve in-plane uniformity of exit light. Further, light enters a thin light guide plate (10c) provided above the groove (18) from light guide plates (10a, 10b) provided on both sides of the groove (18), and the light exits also from a front surface of the light guide plate (10) provided immediately above the LEDs (12).

### CROSS-REFERENCE TO RELATED APPLICATION

The present application claims priority from Japanese application JP 2011-261219 filed on Nov. 30, 2011, the content of which is hereby incorporated by reference into this application.

### BACKGROUND OF THE INVENTION

1. Field of the Invention

The present invention relates to a surface light source device, in particular, for example, a technology for obtaining planar light emission from a non-surface light source, such as a light emitting diode (LED).

2. Description of the Related Art

In a liquid crystal display device used for a display of a personal computer or the like or a liquid crystal television set, each pixel of a liquid crystal panel for forming an image does not emit light by itself. Therefore, the liquid crystal display device includes a light source for irradiating the liquid crystal panel with light, so that the image formed by the liquid crystal panel is visually displayed by transmission light or reflection light from the liquid crystal panel. As the light source, for example, a surface light source device called backlight device disposed behind the liquid crystal panel is used. In this case, an image is displayed by transmission light from the liquid crystal panel.

The backlight device is classified into an edge-light or side-light type backlight device and a direct type backlight device. In the edge-light type backlight device, a point light source or a linear light source (collectively referred to as “non-surface light source”) is disposed at the edge face (edge) of the side of the light guide plate, and light emitted from the non-surface light source is propagated through the light guide plate to spread in a planar form so as to exit from a surface of the light guide plate opposed to the liquid crystal panel. In the direct type backlight device, a plurality of non-surface light sources are arrayed in a planar form, and light emitted from the plurality of non-surface light sources is converted to uniform light by a diffusion plate or the like disposed in front thereof. Examples of the non-surface light source include a cold cathode fluorescent lamp (CCFL) and an LED. In recent years, the LED has become mainstream. The edge-light type backlight device has an advantage over the direct type backlight device in that thinning can be achieved.

### SUMMARY OF THE INVENTION

In the edge-light type backlight device, on the other hand, the light source is mounted at the edge of the light guide plate, and hence the planar shape of the backlight device is increased correspondingly, leading to a problem in that narrowing of the frame is difficult to achieve.

Note that, in FIG. 1 of Japanese Patent Application Laid-open No. 2005-310611 and FIG. 6 of Japanese Patent Application Laid-open No. 2006-351522, there is disclosed a structure in which, at both edges of two light guide plates stacked via a light shielding plate, concave reflective plates for guiding light from the lower light guide plate to the upper light guide plate are disposed, and a light source is disposed at a center portion of the lower light guide plate. In this type, the reflective plate that is convex outward is disposed instead of the light source in the edge-light type, and hence there is also a problem in that the narrowing of the frame is difficult to achieve.

The present invention provides a surface light source device capable of achieving both thinning and narrowing of the frame.

According to an exemplary embodiment of the present invention, there is provided a surface light source device, including: a linear light source; a light guide plate for spreading light that has entered from the linear light source into planar light and emitting the planar light from a first principal surface of the light guide plate; and an edge-face reflective member disposed at an edge face of the light guide plate, for mirror-reflecting light inside the light guide plate that has reached the edge face, so as to return the light to inside of the light guide plate, in which the light guide plate includes a groove formed in a second principal surface thereof, and the linear light source is disposed in the groove of the light guide plate, and allows light to enter the light guide plate from both side surfaces of the groove.

In an example of the surface light source device according to the exemplary embodiment of the present invention, the linear light source includes a plurality of light emitting diodes arrayed at equal intervals along the groove so that each light exit surface thereof faces one of the side surfaces of the groove, and a plurality of light emitting diodes arrayed at equal intervals along the groove so that each light exit surface thereof faces another of the side surfaces.

Another example of the surface light source device according to the exemplary embodiment of the present invention further includes a groove portion reflective member disposed at a bottom surface of the groove of the light guide plate, for reflecting light emitted from the linear light source.

In yet another example of the surface light source device according to the exemplary embodiment of the present invention, in the light guide plate, the first principal surface or both the second principal surface and a bottom surface of the groove are subjected to processing for diffusing and reflecting light propagating through the light guide plate.

Still another example of the surface light source device according to the exemplary embodiment of the present invention further includes: a substrate to which the linear light source is fixed; and positioning means for preventing a deviation of the light guide plate in a direction intersecting with the groove, in which the groove is formed along a straight line crossing a center portion of the light guide plate, and the positioning means fixes the light guide plate to the substrate at a center portion of the light guide plate in a direction orthogonal to the groove.

### BRIEF DESCRIPTION OF THE DRAWINGS

In the accompanying drawings:

FIG. 1 is a schematic perspective view illustrating a schematic structure of a backlight device according to an embodiment of the present invention;

FIG. 2 is a schematic plan view of the backlight device according to the embodiment of the present invention; and

FIG. 3 is a schematic vertical cross-sectional view of the backlight device according to the embodiment of the present invention.

### DETAILED DESCRIPTION OF THE INVENTION

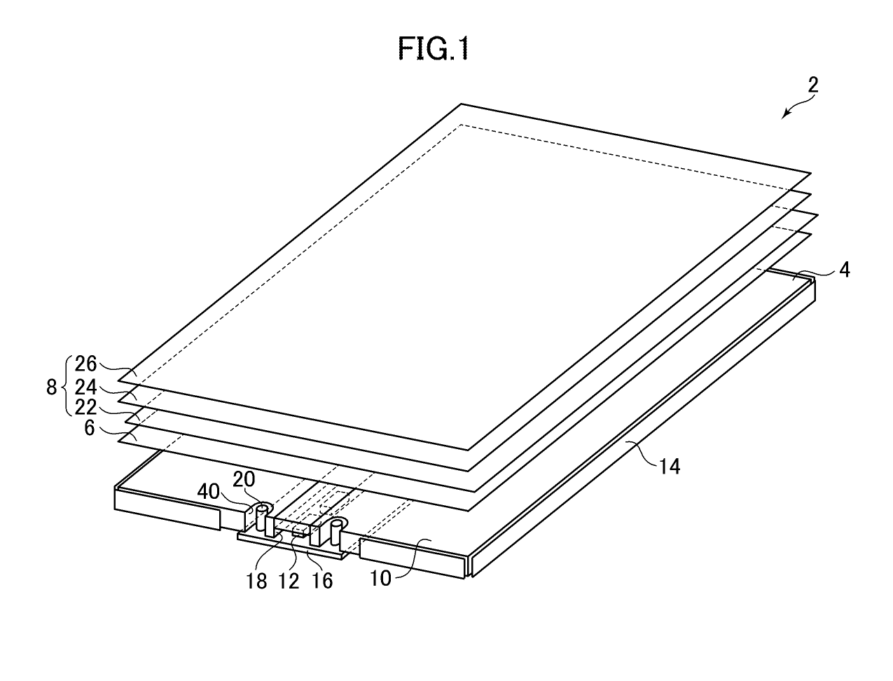

In the following, an embodiment of the present invention is described with reference to the accompanying drawings. FIG. 1 is a schematic perspective view illustrating a schematic structure of a backlight device 2 according to the embodiment of the present invention. As illustrated in FIG. 1, the backlight device 2 includes a light source portion 4 for producing planar light from a non-surface light source with the use of a light guide plate, a diffusion plate 6, and an optical sheet group 8. The light source portion 4, the diffusion plate 6, and the optical sheet group 8 are housed in a case (not shown). For example, the case is formed into a box shape having a backplate for supporting a back surface of the light source portion 4 and side plates provided upright from the periphery of the backplate toward the front surface side. The light source portion 4 and other components are housed inside the case.

The light source portion 4 includes a light guide plate 10 and LEDs 12, and spreads emitted light of the LEDs 12 as the non-surface light sources by the light guide plate 10 so that planar light exits from one principal surface (front surface) of the light guide plate 10. At the edge face of the light guide plate 10, a mirror-finished reflective sheet 14 (edge-face reflective member) is bonded. Further, on the other principal surface (rear surface) of the light guide plate 10, a reflective sheet (not shown) is disposed. The LEDs 12 are mounted on a substrate 16. The substrate 16 is disposed opposed to the other principal surface (rear surface) of the light guide plate 10, and the LEDs 12 are inserted in a groove 18 provided in the rear surface of the light guide plate 10. For example, the substrate 16 is fixed to the backplate of the case positioned therebehind. Catches 20 are provided for preventing the light guide plate 10 from deviating to collide with the LED 12. For example, each of the catches 20 is a pin-like protrusion fixed to the substrate 16 or the case. At the edge of the light guide plate 10, notches or holes are formed, and the catches 20 are inserted therein to prevent a deviation of the light guide plate 10.

The diffusion plate 6 diffuses light emitted from the light source portion 4 to improve in-plane uniformity of light intensity. The optical sheet group 8 may include, for example, a diffusion sheet 22, a prism sheet 24, a reflective polarization film 26, and the like. The diffusion sheet 22 further diffuses light transmitted through the diffusion plate 6, to thereby improve the uniformity more. The prism sheet 24 condenses light exiting from the diffusion sheet 22 to the front surface in various directions, with the direction perpendicular to the plane as the center, to thereby improve brightness of an emission surface at the front. The dual brightness enhancement film (DBEF) 26 as the reflective polarization film reflects a polarized component of incident light which has not transmitted through a lower polarizing plate of the liquid crystal panel just before the lower polarizing plate so that this polarized component can be reused, to thereby improve the brightness.

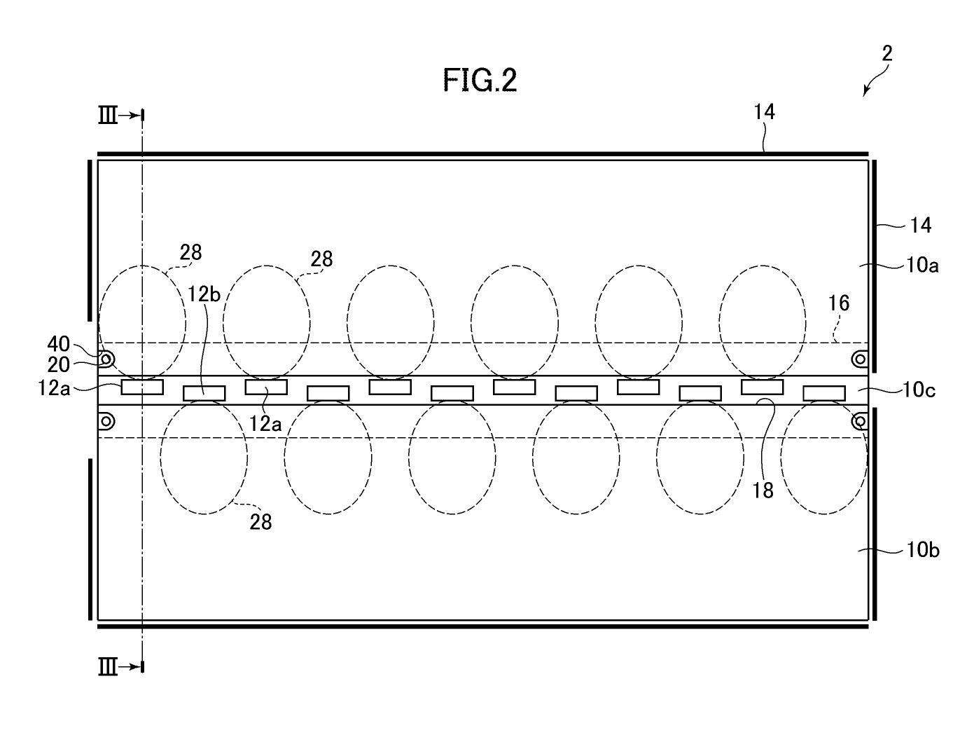

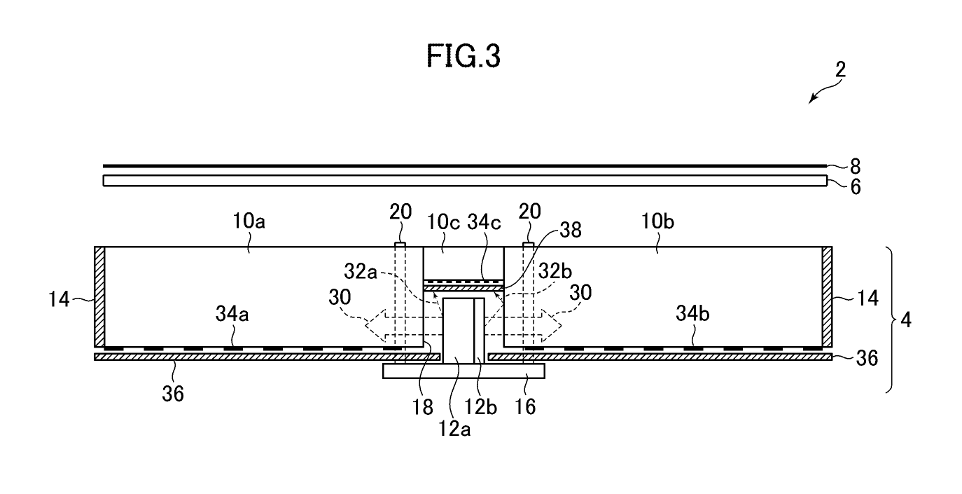

FIG. 2 is a schematic plan view of the backlight device 2. FIG. 2 omits the diffusion plate 6 and the optical sheet group 8. FIG. 3 is a schematic vertical cross-sectional view of the backlight device 2 taken along the line illustrated in FIG. 2. Referring to FIGS. 2 and 3, the structure of the backlight device 2 is described in more detail.

The planar shape of the light guide plate 10 is a rectangle elongated in a lateral direction (horizontal scanning direction) correspondingly to a television liquid crystal panel using the backlight device 2. The groove 18 is formed into a straight line along the lateral direction so as to pass through the center of the light guide plate 10 in a longitudinal direction (vertical scanning direction). The width and depth of the groove 18 are set so that the LEDs 12 can be inserted therein. In this case, in consideration of thermal expansion or deviation of the light guide plate 10, it is preferred to provide a margin to the width or the depth of the groove 18 so that the light guide plate 10 and the LED 12 do not collide with each other.

In this embodiment, the light guide plate 10 is formed by bonding light guide plates 10a and 10b positioned on both sides of the groove 18 and a compact light guide plate 10c positioned at the bottom of the groove 18 with the use of, for example, a transparent adhesive or the like. The compact light guide plate 10c is thinner than the light guide plates 10a and 10b on both sides thereof. The light guide plates 10a, 10b, and 10c are bonded together so that the front surfaces thereof may be flush with each other. In this manner, the groove 18 is formed on the rear side of the light guide plate 10c. Note that, the groove 18 may be formed by cutting a rear surface of a light guide plate having a uniform thickness. Alternatively, a die may be used for a resin-molded light guide plate to integrally mold the light guide plate 10 having the groove 18.

The LEDs 12 are arrayed on the substrate 16 in a straight line to constitute a linear light source. The substrate 16 is, for example, a printed substrate formed by using a rigid substrate made of a low thermal expansion material. As an example, a glass epoxy substrate can be used. On the substrate 16, a conductor pattern for supplying drive power to the LEDs 12 is formed. The substrate 16 is disposed so that its substrate surface faces the rear surface of the light guide plate 10. The LEDs 12 mounted on the substrate surface are inserted in the groove 18.

The LED 12 used is a side-emission type LED. The LED 12 is disposed on the substrate 16 so that its light exit surface faces a side surface of the groove 18. On the substrate 16, there are arranged a plurality of LEDs 12 arrayed at equal intervals along the groove 18 so that each light exit surface thereof faces one side surface of the groove 18 and a plurality of LEDs 12 arrayed at equal intervals along the groove 18 so that each light exit surface thereof faces the other side surface of the groove 18. In this embodiment, LEDs 12a for emitting light toward the light guide plate 10a and LEDs 12b for emitting light toward the light guide plate 10b are arrayed alternately along the groove 18 in the lateral direction.

When the distance between the exit surface of the LED 12 and the side surface of the groove 18 opposed thereto is increased, an irradiation region 28 of the light guide plate 10, where the emitted light of the LED 12 entering from the side surface of the groove 18 reaches directly, is enlarged, and accordingly the brightness unevenness caused by arranging the irradiation regions 28 periodically along the groove 18 can be reduced. On the other hand, when the distance is increased, a component (beam 32a) of emitted light 30 of the LED 12 which does not enter the side surface may increase due to light distribution of the emitted light 30 regarding the normal direction of the light guide plate 10. The distance between the LED 12 and the side surface of the groove 18 is set in consideration of such influence. The same distance is basically set for the LED 12a and the LED 12b. As a result, a difference occurs between the position of the LED 12a and the position of the LED 12b in the width direction of the groove 18, and hence the LEDs 12 may be arranged in a staggered manner as illustrated in FIG. 2. Alternatively, the LEDs 12a and 12b may be arrayed in a straight line. Note that, the LEDs 12 may be arranged in the groove 18 in two rows, one of which is the LEDs 12a and the other is the LEDs 12b.

The light that has entered from the side surface of the groove 18 is repeatedly totally reflected by the front surface and the rear surface in the light guide plate 10, and propagates toward the outer circumference of the light guide plate 10. The mirror-finished reflective sheet 14, which is bonded on the outer edge face of the light guide plate 10, mirror-reflects light that has propagated through the light guide plate 10 to reach the edge face and returns the light into the light guide plate 10. The light reflected by the edge face is repeatedly totally reflected again by the front surface and the rear surface of the light guide plate 10, and propagates in the direction to the groove 18.

In the light guide plate 10, in order that light may exit from the front surface at uniform intensity, the front surface or both the rear surface and the bottom surface of the groove 18 are subjected to processing for diffusing and reflecting the light propagating through the light guide plate. In this embodiment, the rear surface of the light guide plate 10 and the bottom surface of the groove 18 are subjected to the processing. Specifically, as the processing, a white reflective film 34 is formed by printing on the rear surfaces of the light guide plates 10a and 10b and the rear surface of the light guide plate 10c forming the bottom surface of the groove 18. The white reflective film 34 diffuses and reflects incident light at high reflectivity to return the light to the light guide plate 10. White reflective films 34a and 34b on the respective rear surfaces of the light guide plates 10a and 10b and a white reflective film 34c on the rear surface of the light guide plate 10c are formed into such a pattern that the light emission intensity from the front surface of the light guide plate 10 becomes uniform, for example, a dot pattern.

A reflective sheet 36 provided on the rear surfaces of the light guide plates 10a and 10b reflects light leaking from the rear surface of the light guide plate 10 to return the leakage light to the light guide plate 10, to thereby improve light emission efficiency of the backlight device 2.

Note that, in the case where the white reflective film 34 is formed on the front surface of the light guide plate 10, of the light diffused and reflected by the front surface, a component that has entered the rear surface at an angle at which no total reflection occurs is reflected by the reflective sheet 36 on the rear surface and exits from a gap of the pattern of the white reflective film 34 on the front surface. In the configuration in which the white reflective film 34 is formed on the front surface, the white reflective films 34 of the light guide plates 10a, 10b, and 10c can be formed to be flush with each other. With this, it is possible to relatively easily design the pattern of the white reflective film 34 for reducing the influence of the brightness unevenness caused by a step at the boundary between the light guide plate 10a or 10b and the light guide plate 10c on the rear surface.

On the rear surface of the light guide plate 10c, that is, on the bottom surface of the groove 18, a reflective sheet 38 (groove portion reflective member) is provided. The reflective sheet 38 reflects the beam 32a, which enters directly from the LED 12, and a beam 32b corresponding to a Fresnel loss component, which is reflected by the side surface and does not enter the light guide plates 10a and 10b. With this emitted light of the LED 12 that has not diffused sufficiently is inhibited from being transmitted to the front surface, and a bright line can be prevented from being generated at a position on the front surface of the light guide plate corresponding to the groove 18. Further, the reflective sheet 38 can reflect light also at a surface on the light guide plate 10c side, and therefore functions similarly to the reflective sheet 36.

In the vicinity of the side surface of the groove 18, the brightness unevenness occurs in accordance with the arrangement period of the LEDs 12. Further, the brightness unevenness may also occur by a step at the boundary between the light guide plate 10a or 10b and the light guide plate 10c. In addition, the brightness of the front surface in the vicinity of the LEDs 12 may be lower than the brightness at a position apart from the LEDs 12, because light is caused to exit from the LEDs 12 toward the side surface of the groove 18, that is, in the direction along the plane of the light guide plate 10, and because the reflective sheet 38 is disposed. The above-mentioned configurations of the light guide plate 10 and the like can alleviate such brightness unevenness to improve the uniformity of light exiting from the front surface of the light guide plate 10. Specifically, the light is returned to the groove 18 side by the mirror-finished reflective sheet 14, and hence the above-mentioned brightness unevenness becomes less conspicuous in the vicinity of the groove 18. Further, the light guide plate 10c is disposed above the LEDs 12, and the light reflected by the mirror-finished reflective sheet 14 is caused to enter the light guide plate 10c to exit from the front surface thereof. In this manner, the reduction in brightness immediately above the LEDs 12 can be compensated for.

The catches 20 are positioning means for preventing a deviation of the light guide plate 10 in a direction intersecting with the groove 18. With the catches 20, the light guide plate 10 can be prevented from deviating to collide with the LED 12 or decrease the optical performance.

In this case, one cause for the deviation of the light guide plate 10 is thermal expansion of the light guide plate 10. A positional deviation caused by thermal expansion at another point with respect to a certain point on the light guide plate 10 is accumulated to become larger in accordance with the distance between the two points. Therefore, positional deviation amounts on both ends of the light guide plate 10 in the case where the light guide plate 10 is fixed at the center are half a positional deviation amount caused by thermal expansion on one end in the case where the light guide plate 10 is fixed at the other end. In view of this, the position of each of the catches 20 in the direction orthogonal to the groove 18 is set to a center portion of the light guide plate 10. With this, the maximum value of the positional deviation amount in the plane of the light guide plate 10 can be reduced. In addition, the positional deviation amount caused by thermal expansion at the center portion corresponding to the vicinity of the fixing position becomes smaller, and hence the fluctuation in distance between the LED 12 disposed at the center portion and the side surface of the groove 18 is reduced, to thereby suppress the fluctuation in optical characteristics and prevent the breakage and the like of the LED 12.

Specifically, the catches 20 are disposed at the right edge and the left edge of the light guide plate 10 in the lateral direction. At each of the left and right edges, one catch 20 is provided on each side of the groove 18. The catches 20 are inserted in notch portions 40 formed in the light guide plates 10a and 10b.

Note that if the light guide plate 10c thinner than the light guide plates 10a and 10b has sufficient strength, each of the catches 20 may be disposed at a position on the light guide plate 10c closer to the center. Further, in the compact backlight device 2, the weight of the light guide plate 10 and other members is small, and hence, for example, an adhesive, pressure-sensitive tape, or the like may be used as the positioning means so as to fix the center portion of the light guide plate 10 in the direction orthogonal to the groove 18.

Further, in the above-mentioned embodiment, the LEDs 12 as the light source are arranged in the lateral direction so as to cross the center of the light guide plate 10 in the longitudinal direction. Alternatively, however, the LEDs 12 may be arranged in the longitudinal direction so as to cross the center of the light guide plate 10 in the lateral direction, or a cross-shaped groove may be formed in the light guide plate 10 and the LEDs 12 may be arrayed in the lateral direction and the longitudinal direction.

According to the surface light source device of the present invention described above by way of the embodiment, the thinning comparable to the edge-light type device can be achieved, and the narrowing of the frame can be achieved more than the conventional edge-light type device by disposing the light source in the plane of the light guide plate. In addition, the surface light source device of the present invention has a structure for obtaining uniform in-plane intensity of the exit light, and hence the brightness unevenness caused by disposing the light source in the plane of the light guide plate can be suppressed. The present invention is also applicable to a surface light source device for other applications than the above-mentioned backlight device of a liquid crystal display device.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A surface light source device, comprising:
a linear light source;
a light guide plate for spreading light that has entered from the linear light source into planar light and emitting the planar light from a first principal surface of the light guide plate; and
an edge-face reflective member disposed at an edge face of the light guide plate, for mirror-reflecting light inside the light guide plate that has reached the edge face, so as to return the light to inside of the light guide plate, wherein
the light guide plate includes a groove formed in a second principal surface thereof, and
the linear light source is disposed in the groove of the light guide plate, and allows light to enter the light guide plate from both side surfaces of the groove.

2. The surface light source device according to claim 1, wherein the linear light source comprises a plurality of light emitting diodes arrayed at equal intervals along the groove so that each light exit surface thereof faces one of the side surfaces of the groove, and a plurality of light emitting diodes arrayed at equal intervals along the groove so that each light exit surface thereof faces another of the side surfaces.

3. The surface light source device according to claim 1, further comprising a groove portion reflective member disposed at a bottom surface of the groove of the light guide plate, for reflecting light emitted from the linear light source.

4. The surface light source device according to claim 1, wherein, in the light guide plate, the first principal surface or both the second principal surface and a bottom surface of the groove are subjected to processing for diffusing and reflecting light propagating through the light guide plate.

5. The surface light source device according to claim 1, further comprising:
a substrate to which the linear light source is fixed; and
positioning means for preventing a deviation of the light guide plate in a direction intersecting with the groove, wherein
the groove is formed along a straight line crossing a center portion of the light guide plate, and
the positioning means fixes the light guide plate to the substrate at a center portion of the light guide plate in a direction orthogonal to the groove.
